(19) United States
(12) Patent Application Publication
(10) Pub. No.: US 2015/0349315 A1
(43) Pub. Date: Dec. 3, 2015

(54) BATTERY POST TERMINAL CONNECTOR

(71) Applicant: KALAS MANUFACTURING, INC., Lancaster, PA (US)

(72) Inventors: Kevin SHOPE, Denver, PA (US); Tony HATT, Ephrata, PA (US); Jared REED, Palmyra, PA (US); Sean NEWKIRK, Mt. Joy, PA (US); Antonio COLON, East Fallowfield, PA (US)

(21) Appl. No.: 14/724,030

(22) Filed: May 28, 2015

Related U.S. Application Data
(60) Provisional application No. 62/003,922, filed on May 28, 2014.

(51) Int. Cl. H01M 2/20

(52) U.S. Cl. CPC H01M 2/206; H01M 2220/20

(57) ABSTRACT

A battery terminal connector and process of manufacture. The battery terminal includes a connector body formed of an alloy comprising up to about 8.8 percent aluminum, up to 0.06 about percent magnesium, up to about 0.075 percent iron, up to about 0.006 percent lead, up to about 0.006 percent cadmium, up to 0.003 percent tin, up to 1.3 percent copper, the balance being zinc, all of said percentages being by weight of the composition. The connector is gravity molded or pressure cast, resulting in a battery terminal connector having high strength and electrical conductivity and good corrosion resistance.

### FIELD OF THE INVENTION

The invention relates to terminals or connectors for batteries. In particular, the invention relates to a lead alternative insert molded battery post terminal connector.

### BACKGROUND OF THE INVENTION

Many batteries, such as vehicular lead acid batteries, have posts that extend upward from the battery to provide an external electrical connection point. To establish an electrical connection between the battery and the appliance or electrical system that draws power from the battery, terminals are fastened to the posts, and electrical cables are attached to the terminals.

For vehicular applications, these terminals have traditionally been made of lead. Since the posts in vehicular batteries are typically made of lead or lead alloy, lead terminals make a good electrical connection to the battery. Lead is also resistance to sulfuric acid.

For decades, the SAE J537 and SAE J1811 Standards have combined to define the requirements for the interfacing connection of a 12-24V DC battery-cable assembly as used in the electrical starting system for on and off road vehicles.

In recent years, some vehicle manufacturers have moved away from lead tapered post batteries to threaded versions, or have opted for copper-alloy and plated steel “crimp-on” clamp terminals to handle RoHS compliance and waste stream issues at end of life on battery cables. Currently, unlike batteries that have a near 100% recycling program, battery cables are not recycled and any lead content moves into the waste stream.

Current RoHS compliance requires that assemblies have a maximum of 0.1% lead, as well as other targeted elements. To achieve that level of compliance on battery cables, complete elimination of lead based alloys from terminals is required.

It would, therefore, be beneficial to provide a lead-free battery post terminal which is durable, corrosion resistant, cost effective and which can be manufactured in different configurations. It would also be beneficial to provide a terminal in which the lead-free alloy is molded and encapsulates an end of the cable.

### SUMMARY

An embodiment is directed to a zinc-zinc alloy diecast battery post clamp terminal.

An embodiment is directed to a zinc-zinc alloy diecast battery post clamp terminal with a metal clip insert to meet clamping force and unloading requirements.

An embodiment is directed to a zinc-zinc alloy diecast battery post clamp terminal with a protective coating or plating to resist environmental corrosion attack.

An embodiment is directed to a zinc-zinc alloy diecast battery post clamp terminal for accommodating multiple single electrical conductors.

An embodiment is directed to a zinc-zinc alloy diecast battery post clamp terminal manufactured using but limited to gravity and pressure casting process methods.

An embodiment is directed to a tin-zinc alloy pre-solder dipped electrical conductor insert molded into a zinc-zinc alloy diecast battery post clamp terminal.

An embodiment is directed to a thermoplastic or thermoset insulated electrical conductor insert molded into a zinc-zinc alloy diecast battery post clamp terminal.

An embodiment is directed to a zinc-zinc alloy diecast insert over molded splice with multiple terminating electrical conductors, such as, but not limited to, tin-zinc pre-solder dipped conductors. The over molded splice may be over molded with an insulating layer of thermoplastic or thermoset plastics.

An embodiment is directed to a battery terminal connector which includes a connector body which has a clamping end for mounting to a terminal post and a termination end for terminating to a cable. The termination end is overmolded over a termination end of the cable. The connector body is formed of an alloy comprising up to 4.7 percent aluminum, up to 0.06 percent magnesium, up to 0.05 percent iron, up to about 0.005 percent lead, up to 0.04 percent cadmium, up to 0.002 percent tin, up to 0.1 percent copper, the balance being zinc, all of said percentages being by weight of the composition. The connector is gravity molded or pressure cast, resulting in a battery terminal connector having high strength and electrical conductivity and good corrosion resistance.

An embodiment is directed to a battery terminal connector which includes a connector body which has a clamping end for mounting to a terminal post and a termination end for terminating to a cable. The termination end is overmolded over a termination end of the cable. The connector body is formed of an alloy comprising up to about 8.8 percent aluminum, up to 0.06 about percent magnesium, up to about 0.075 percent iron, up to about 0.006 percent lead, up to about 0.006 percent cadmium, up to 0.003 percent tin, up to 1.3 percent copper, the balance being zinc, all of said percentages being by weight of the composition. The connector is gravity molded or pressure cast, resulting in a battery terminal connector having high strength and electrical conductivity and good corrosion resistance.

An embodiment is directed to a terminal connector or splice which includes a connector body formed of an alloy comprising up to 4.7 percent aluminum, up to 0.06 percent magnesium, up to 0.05 percent iron, up to about 0.005 percent lead, up to 0.04 percent cadmium, up to 0.002 percent tin, up to 0.1 percent copper, the balance being zinc, all of said percentages being by weight of the composition. The connector is gravity molded or pressure cast, resulting in a battery terminal connector having high strength and electrical conductivity and good corrosion resistance.

An embodiment is directed to a terminal connector or splice which includes a connector body formed of an alloy comprising up to about 8.8 percent aluminum, up to 0.06 about percent magnesium, up to about 0.075 percent iron, up to about 0.006 percent lead, up to about 0.006 percent cadmium, up to 0.003 percent tin, up to 1.3 percent copper, the balance being zinc, all of said percentages being by weight of the composition. The connector is gravity molded or pressure cast, resulting in a battery terminal connector having high strength and electrical conductivity and good corrosion resistance.

An embodiment is directed to a process of forming a battery terminal connector, the process comprising; heating a reduced lead alloy; gravity molding or pressure casting the alloy into a mold; overmolding the alloy over a termination end of a cable; solidifying the alloy; and removing the alloy with the overmolded cable from the mold. The process may optionally include pretreating the termination end of the cable with solder to bond individual conductors of the cable together. The process may optionally include applying a coating to a surface of the battery terminal connector to seal the surface against penetration and corrosion by sulphuric acid.

### BRIEF DESCRIPTION OF THE DRAWINGS

FIG. 1 is a perspective view of an illustrative embodiment of a battery terminal connector attached to a battery post of a battery.

FIG. 2 is a perspective view of an illustrative embodiment of a battery terminal connector with a battery post exploded therefrom.

FIG. 3 is a perspective view of an alternate illustrative embodiment of a battery terminal connector with a strengthening clip positioned therein.

### DETAILED DESCRIPTION OF THE INVENTION

The present invention will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that spatially relative terms, such as “top”, “upper”, “lower” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “over” other elements or features would then be oriented “under” the other elements or features. Thus, the exemplary term “over” can encompass both an orientation of over and under. The device may be otherwise oriented (rotated 90 degrees or at other orientations) and the spatially relative descriptors used herein interpreted accordingly.

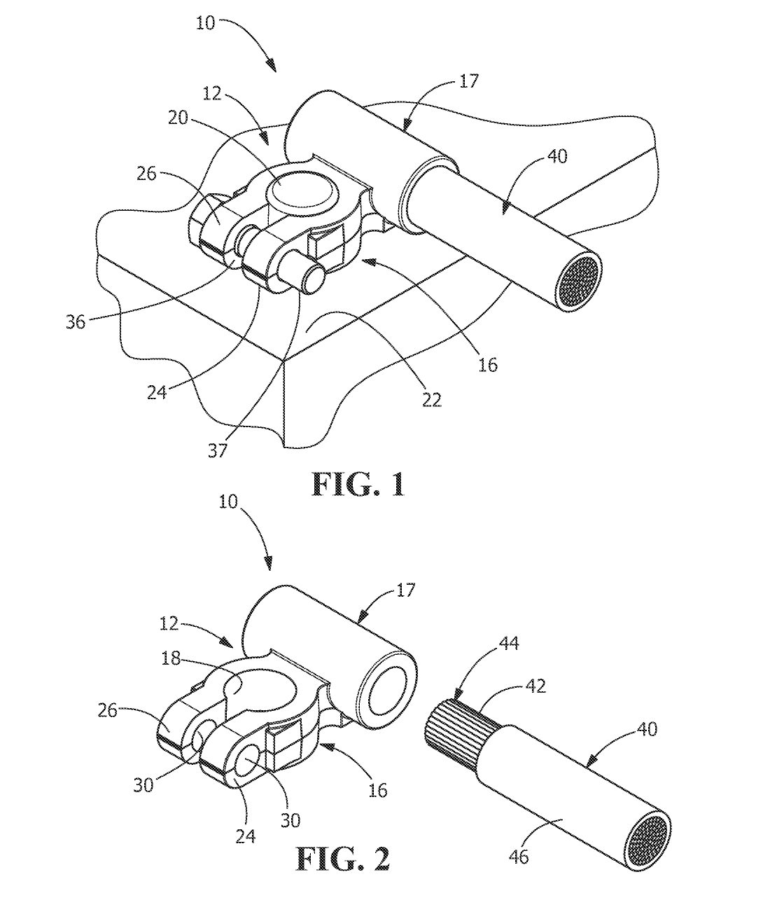

An embodiment is directed to a battery terminal connector for connecting and disconnecting to a terminal post, such as a battery terminal post or to a terminal for splicing electrical wires. Referring to FIGS. 1 and 2, an exemplary embodiment of a battery terminal connector 10 of the present invention is shown. The connector 10 includes a connector body 12 which includes a clamping end or stirrup 16 and an opposed termination end 17 extending therefrom.

The clamping end 16 includes an aperture 18 extending therethrough which is designed for accommodation over an upstanding terminal post 20 of a battery 22. The aperture 18 forms nearly a full circle to encompass the post 20. The clamping end 16 further includes a pair of spaced apart outwardly extending movable clamping arms or lugs 24, 26 which provide for clamping engagement about the post 20.

The clamping arms 24, 26 are separated by a slot 36 which extends to the aperture 18. The width of the slot 36 may vary depending upon whether the connector 10 is in a clamped (closed) or an unclamped (open) position, as will be more fully described.

The clamping arms 24, 26 are generally rectangular with a curved outer end. A mounting opening 30 (as best shown in FIG. 2) extends through the clamping arms 24, 26 adjacent the curved outer end. The clamping arms 24, 26 have an inner surface adjacent the slot 36 and an outer surface opposite the inner surface.

A bolt, screw, lever or other activation device 37 (FIG. 1) may be positioned in the mounting openings 30. The activation device is provided to move the battery connector 10 from the open or unclamped position to the closed or clamped position in which the connector body 12 is clamped to the terminal post 20 of battery 22. As the activation device is moved, the deformable clamping arms 24, 26 are moved inwardly to clamp the connector body 12 about terminal post 20. The activation device may create a gradient force which causes the clamping arms 24, 26 to provide secure clamping engagement about the post 20. The activation device 37 also creates a controlled, specific and repeatable force which causes a specific movement or deformation of the clamping arms 24, 26 and the aperture 18, which in turn provides a controlled, specific and repeatable electrical connection between the connector 10 and the terminal post 20.

As the connector 10 of the present invention is designed to terminate an electrical cable, such as a battery cable, to the terminal post 20 of the battery 22, the body 12 of the connector 10 is formed of an electrically conductive metal.

The termination end or cable mount 17 allows accommodation of the stripped end of an electrical cable 40, such as a battery cable. The termination end 17 is the point of contact between the terminal and the electrical cables. The termination end 17 refers generically to the portion of the terminal that makes electrical contact with the cable or cables. As shown in FIG. 1, the termination end 17 is overmolded over the battery cable. This provides a secure mechanical and electrical connection. As the cable is insert molded, the connection between the cable and termination end 17 of the terminal connector 10 is sealed and resistant to corrosion. Alternatively, other configurations of the termination end 17 may be used without departing from the scope of the invention.

In illustrative embodiments, the termination end 44 of the cable 40 may be pretreated to facilitate a better mechanical and/or electrical connection with the overmolded connector 10. As an example, a tin, zinc, tin/zinc alloy or solder may be applied to the exposed conductors of the cable prior to the overmold process to form a solder member 42. The application of the solder bonds the individual conductor or wires of the cable together, thereby strengthening the termination end and solidifying the irregular shapes of the wires. In addition, the solder solidifies to provide a rough outer surface which cooperates with the overmolded connector 10 to enhance the mechanical bond there between.

Examples of such a solder used to provide an adequate wetting surface for the zinc alloy over mold in the conductor cable include a 60/40 tin-zinc alloy solder and a 70/30 tin-zinc alloy solder. In most cases the copper conductor cable strands begin to fail before the solder itself pulls off or fails.

The present invention can be used with many different types of batteries and battery terminals. For instance, the illustrative embodiment shows a right angle terminal connector 10. However, other types of the terminal connectors, such as but not limited to, straight, vertical and T cut can be used.

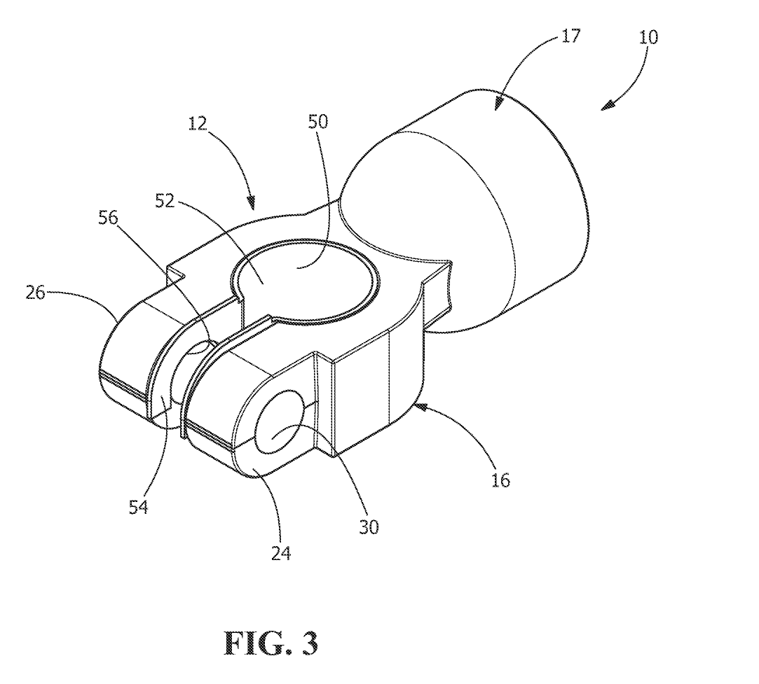

In various illustrative embodiments, such as shown in FIG. 3, an optional clip or spring member 50 may be provided. The clip 50 is configured to approximate the general shape of the clamping end 16 of the connector 10. The clip 50 may be insert molded in the clamping end 16 to provide enhanced strength and durability of the clamping end 16. The clip 50 is generally U-shaped with a semi-circular section 52 and generally parallel planar ends 54, 56. The ends 54, 56 have aligned apertures or openings 56 which are aligned with apertures or opening 30 of clamping arms 24, 26 when the clip 50 is positioned in the clamping end 16. The clip 50 may be stamped and formed from any material having the appropriate strength and resilient characteristics required.

However, although an internal spring clip 50 may be used in certain applications, such clips are not required in many applications. If point stresses are properly minimized in certain areas of the clamping end 16 of the connector 10, the clip 50 is not needed.

The battery terminal connectors 10 may be manufactured from any suitable lead-free or reduced lead (0.1% or less by weight) material compatible with the environment in which they are intended to be used. The battery terminal connectors can be made from, but are not limited one of the following alloys which exhibit good electrical conductivity, proper corrosion resistance and sufficient strength. The following three examples represent compositions suitable for use for the clamping end 16 and the termination end 17 of the connector body 12 of the battery terminal connector 10:

### EXAMPLE I

Aluminum 4.3 to 4.7%

Copper Up to 0.035% maximum

Magnesium 0.005 to 0.012%

Iron Up to 0.03% maximum

Lead Up to 0.003% maximum

Cadmium Up to 0.002% maximum

Tin Up to 0.001% maximum

Zinc Balance

### EXAMPLE II

Aluminum 3.7 to 4.3%

Copper Up to 0.1% maximum

Magnesium 0.02 to 0.06%

Iron Up to 0.05% maximum

Lead Up to 0.005% maximum

Cadmium Up to 0.004% maximum

Tin Up to 0.002% maximum

Zinc Balance

### EXAMPLE III

Aluminum 8.0 to 8.8%

Copper 0.8 to 1.3%

Magnesium 0.01 to 0.03%

Iron Up to 0.075% maximum

Lead Up to 0.006% maximum

Cadmium Up to 0.006% maximum

Tin Up to 0.003% maximum

Zinc Balance

In each of the above examples, the percentages are by weight of the composition, and it will be noted that in each case the major portion of the composition comprises zinc which is the balance of the composition in each of the three examples. The percentages of the various minerals in each of the above alloys may be varied slightly without departing from the scope of the present invention.

In the Examples recited above, the battery terminal connector 10 is formed of a zinc base alloy comprising aluminum, copper, cadmium, tin, lead, magnesium, iron and zinc within certain critical ranges. During forming of the terminal connector 10, the zinc alloy is heated to a molten state and the molten alloy is then pressure or gravity molded.

In the present invention, the method of making the electrical connector 10 includes the steps of heating one of the lead-free or reduced lead alloy to a molten state at a particular temperature. Either pressure or gravity molding the molten alloy at a particular pressure and for a specific time to form an electrical connector. Specifically, the method of making the electrical connector includes the steps of heating one of the one of the zinc alloys to a molten state at about 800 degrees Fahrenheit.

During the molding process, the termination end 44 of the cable 40 is maintained in the mold cavity, thereby allowing the molten alloy to flow about the termination end 44 and the solder member 42. In so doing the connector 10 is overmolded over the termination end 44 of the cable 40. As the termination end 44 is molded into the connector 10, a secure, rigid mechanical and electrical connection is provided between the connector 10 and the cable 40 when the connector 10 when the alloy is solidified and removed from the mold. The use of the solder member 42 at the termination end 44 of the cable 40 interacts with the molded connector 10 to enhance the mechanical and electrical connection between the connector 10 and the cable. As the solder member 42 has micro peaks and valleys in the outer surface, the molten alloy flows into the valleys to create a more secure bond therebetween when the alloy solidifies.

As the insulation 46 of the cables 40 are exposed to the molten alloy during the formation of the one piece connector 10 and cable, the insulation 46 is preferably made of a material which can withstand the heat of the molten alloy, such as, but not limited to, thermoset insulation. In addition, thermoplastic insulation with a melt temperature higher than the melt temperature of the alloy may be used.

In various illustrative embodiments, the connector 10 may be subject to fast chilling to keep the grain structure of the connector very fine.

In various illustrative embodiments, the alloy or metal is subjected to a chemical treatment or coating to seal the surface of the metal against penetration and intergranular corrosion by sulphuric acid and the like. Such coating may be, but is not limited to nickel or zinc. However, in many application, un-treated alloy diecast terminal connectors can perform well electrically and mechanically for the life expectancy of the product.

In addition, surface treating may be necessary to eliminate visual performance differences in the alloy versus connectors made from lead or other known materials.

The grain structure for alloys, such as zinc alloys, must be minimized in order to provide the correct strength for performance elements such as torque testing. Alloy modifying elements such as silica can provide for better mold flow characteristics, as well as grain size reduction modification. In various illustrative embodiments, the amount of magnesium in the alloy may be adjusted to help prevent intergranular corrosion.

In various illustrative embodiments, the amount of aluminum in the alloy may be adjusted to allow the alloy to have a proper, predictable and reliable flow as the alloy is poured into the mold.

While the invention has been described with reference to an illustrative embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments and methods are therefore to be considered in all respects as illustrative and not restrictive, the scope of the invention being defined by the appended claims, and not limited to the foregoing description or embodiments.

1. A battery terminal connector comprising:
a connector body having a clamping end for mounting to a terminal post and a termination end for terminating to a cable, the termination end overmolded over a termination end of the cable;
the connector body being formed of an alloy comprising up to about 8.8 percent aluminum, up to 0.06 about percent magnesium, up to about 0.075 percent iron, up to about 0.006 percent lead, up to about 0.006 percent cadmium, up to 0.003 percent tin, up to 1.3 percent copper, the balance being zinc, all of said percentages being by weight of the composition;
the connector being gravity molded or pressure cast, resulting in a battery terminal connector having high strength and electrical conductivity and good corrosion resistance.

2. The battery terminal as recited in claim 1, wherein the amount of aluminum is in the range between 3.7 to 8.8 percent by weight of the composition.

3. The battery terminal as recited in claim 1, wherein the cable has thermoplastic insulation.

4. The battery terminal as recited in claim 1, wherein the cable has thermoset insulation.

5. The battery terminal as recited in claim 1, wherein the cable is pretreated with solder to bond individual conductors of the cable together.

6. The battery terminal as recited in claim 5, wherein the solder is a tin-zinc alloy.

7. The battery terminal as recited in claim 1, wherein a spring clip cooperates with the clamping end to provide enhanced strength and durability to the clamping end.

8. The battery terminal as recited in claim 7, wherein the clamping end of the connector body is overmolded over the spring clip.

9. The battery terminal as recited in claim 1, wherein a coating is applied to a surface of the connector body to seal the surface against penetration and corrosion by sulphuric acid.

10. The battery terminal as recited in claim 9, wherein the coating comprises chrome, nickel, zinc, cadmium or cadmium with a trichloroethylene solution.

11. A terminal connector comprising:
a connector body formed of an alloy comprising up to about 8.8 percent aluminum, up to 0.06 about percent magnesium, up to about 0.075 percent iron, up to about 0.006 percent lead, up to about 0.006 percent cadmium, up to 0.003 percent tin, up to 1.3 percent copper, the balance being zinc, all of said percentages being by weight of the composition;
the connector being gravity molded or pressure cast, resulting in a battery terminal connector having high strength and electrical conductivity and good corrosion resistance.

12. The terminal as recited in claim 11, wherein the amount of aluminum is in the range of between 3.7 to 8.8 percent by weight of the composition.

13. The terminal as recited in claim 11, wherein the connector body is overmolded over a termination end of the cable, the termination end of the cable is pretreated with solder to bond individual conductors of the cable together.

14. The terminal as recited in claim 11, wherein a coating is applied to a surface of the connector body to seal the surface against penetration and corrosion by sulphuric acid.

15. The battery terminal as recited in claim 16, wherein the coating comprises nickel or zinc.

16. A process of forming a battery terminal connector, the process comprising;
heating a reduced lead alloy;
gravity molding or pressure casting the alloy into a mold;
overmolding the alloy over a termination end of a cable;
solidifying the alloy;
removing the alloy with the overmolded cable from the mold.

17. The process of forming the battery terminal connector as recited in claim 16 comprising:
pretreating the termination end of the cable with solder to bond individual conductors of the cable together.

18. The process of forming the battery terminal connector as recited in claim 17 comprising:
applying a coating to a surface of the battery terminal connector to seal the surface against penetration and corrosion by sulphuric acid.
